(19) United States
(12) Patent Application Publication
(10) Pub. No.: US 2025/0074126 A1
(43) Pub. Date: Mar. 6, 2025

(54) TRAILER HITCH COVER ASSEMBLY

(71) Applicant: Colby D. Jernigan, Green Sea, SC (US)

(72) Inventor: Colby D. Jernigan, Green Sea, SC (US)

(21) Appl. No.: 18/820,785

(22) Filed: Aug. 30, 2024

Related U.S. Application Data
(60) Provisional application No. 63/535,430, filed on Aug. 30, 2023.

(51) Int. Cl. B60D 1/60

(52) U.S. Cl. CPC B60D 1/605

(57) ABSTRACT

A trailer hitch cover assembly includes an elongated tubular base for substantially surrounding a hitch shaft of a trailer hitch assembly in a form-fitting manner, and at least one ball mount cover integrally joined to the tubular base via a respective flexible tether.

### I. RELATED APPLICATIONS

The present application claims priority to U.S. Provisional Patent Application No. 63/535,430, filed on Aug. 30, 2023, the disclosure of which is hereby incorporated by reference in its entirety.

### II. FIELD OF THE INVENTION

The present application discloses and describes a trailer hitch cover assembly, and more particularly, a trailer hitch cover assembly having a similar configuration to the trailer hitch to which it is installed.

### III. BACKGROUND

A number of devices and apparatuses have been introduced to provide a cover to a standard trailer hitch. Many covers have been utilized to provide a protective element to the trailer hitch, in particular, to provide a guard so that individuals that inadvertently run-into the trailer hitch are not injured upon such a strike. The following references are exemplary but not exhaustive of the types of devices used in covering trailer hitches:

U.S. Pat. No. 5,037,122, issued in the name of Beckerer, Jr. discloses a cover for a trailer hitch which includes an upstanding dome which encircles the ball mount of a trailer hitch, and a shortened base portion;

U.S. Pat. No. 9,809,071 B2, issued in the name of McGuffee discloses a protective cover for trailer coupling devices, the cover includes a shaft with a hollowed inner core for housing a trailer coupling device and a protective pad that is adjoined to one end of the shaft;

U.S. Pat. No. 6,719,318 B1, issued in the name of Blake discloses a trailer hitch cover assembly for a motor vehicle which includes a hitch having insert an aperture extending longitudinally therethrough to fit over a hitch tube of a trailer hitch on a motor vehicle, a rotatable door covering the aperture, a top cover plate mounted to the hitch insert, and a front cover plate mounted to the hitch insert and having an aperture extending therethrough aligned with the hitch tube of the trailer hitch;

U.S. Pat. No. 6,913,278 B1, issued in the name of Laska discloses a bumper having an elastic body shaped to fit on a conventional trailer coupler to prevent damage to the coupler to a towing vehicle during attachment of the coupler to a ball-type hitch on the vehicle, wherein the body has side flanges with longitudinal grooves for receiving coupler lateral flanges and a transverse strap joined to the side flanges to retain the body on the coupler and prevent removal of the bumper when the coupler is attached to the ball-type hitch;

U.S. Pat. No. 5,575,494, issued in the name of DeVries discloses a guard for a trailer coupler having a lateral marginal flange defining a portion of the perimeter thereof, with the guard including a generally U-shaped member having a first longitudinal surface defining a contiguous inside perimeter of the U-shaped member;

U.S. Pat. No. 9,731,570 B1, issued in the name of Rodriguez discloses a vehicle hitch cover for covering a hitch ball of a vehicle hitch is disclosed, the hitch cover including a ball cover portion for concealing the hitch ball and a secondary cover portion providing a mount for the ball cover portion, wherein the ball cover portion includes at least one movable cover that is movable relative to the hitch ball of the vehicle hitch, and the at least one movable cover is movable between a closed position for fully covering and concealing the hitch ball and an opened position for exposing the hitch ball;

U.S. Patent Publication No. 2020/0108680 A1, published in the name of Locklear discloses a protective sheath designed to be attached to a trailer hitch ball mount, wherein the apparatus provides protection to individuals moving around a vehicle fitted with a trailer hitch; and

U.S. Pat. No. 10,099,526 B2, issued in the name of Olson et al. discloses a trailer hitch spring bar cover system for providing clean and safe storage of a trailer weight distribution system including spring bars and towing balls, wherein the cover for a trailer weight distribution spring bar generally includes a first body and a second body movably connected to the first body, and wherein each of the bodies have a first end, a second end, a perimeter edge, a cavity, and a cutout near an end of the body.

Despite these attempts, there is still a need and desire for improvements to trailer hitch and ball mount covers.

This application presents claims and embodiments that fulfill a need or needs not yet satisfied by the products, inventions and methods previously or presently available. In particular, the claims and embodiments disclosed herein describe a trailer hitch cover assembly, the assembly comprises an elongated tubular base for substantially surrounding a hitch shaft of a trailer hitch assembly in a form-fitting manner; and at least one ball mount cover integrally joined to the tubular base via a respective flexible tether, wherein the trailer hitch cover assembly of the present invention providing unanticipated and nonobvious combination of features distinguished from the products, devices, apparatuses, inventions, systems, and methods preexisting in the art. The applicant is unaware of any product, method, device, apparatus, disclosure or reference that discloses the features of the claims and embodiments disclosed and taught herein.

### IV. SUMMARY OF THE INVENTION

In one embodiment, a trailer hitch cover assembly is disclosed. The assembly comprises a unitary mold design construction comprising an elongated tubular base for substantially surrounding or encompassing a hitch shaft of a trailer hitch assembly. The base fits about the hitch shaft in a form-fitting manner. The assembly also includes at least one ball mount cover integrally joined to the tubular base via a respective flexible tether.

The base may be constructed of a flexible, water-proof, open-cell polymer material imparting impact absorption characteristics.

In accordance to another embodiment, the assembly further includes a hook cover coupled to the base via a separate tether. The hook cover may be constructed of a flexible, water-proof, open-cell polymer material imparting impact absorption characteristics.

In another embodiment, a trailer hitch cover assembly comprises an elongated tubular base for substantially surrounding a hitch shaft of a trailer hitch assembly in a form-fitting manner, wherein the base comprises a linearly elongated form having an enclosure for retaining the hitch shaft of the trailer hitch assembly. The assembly further includes at least one ball mount cover integrally joined to the tubular base via a respective flexible tether, each one of the ball mount covers having a half prolate spheroid configuration.

In this embodiment, the assembly includes a number of ball mount covers equal to the number of a corresponding ball mounts.

Also in this embodiment, the assembly comprises a trailer hitch cover assembly is constructed of a flexible, water-proof, open-cell polymer material imparting impact absorption characteristics.

Also in this embodiment, the assembly further comprises a linearly disposed opening that may further assist in the placement or attachment and/or removal of the assembly from the hitch shaft.

In addition, this embodiment includes the ball mount covers coupled to the base via a single tether, the tether comprising a flexible line depending from the base.

Alternatively, the assembly includes each ball mount cover being coupled to the base via separate tethers, wherein the separate tethers each comprise a flexible line depending from the base.

Alternatively, the ball mount cover is coupled each one of the tethers comprises a flexible line depending from the base, each tether securable when not deployed by hook and loop material to the surface of the base

In addition, in this embodiment, each one of the tethers includes hook or loop material coupled to complementary hook or loop material along the elongated surface(s) of the base.

In a separate embodiment, a trailer hitch cover assembly comprises an elongated tubular base for substantially surrounding a hitch shaft of a trailer hitch assembly in a form-fitting manner, wherein the base comprises a linearly elongated form having an enclosure for retaining the hitch shaft of the trailer hitch assembly, wherein the trailer hitch assembly has at least one hook connector. The assembly comprises or has at least one ball mount cover integrally joined to the tubular base via a respective flexible tether, each one of the ball mount covers having a prolate semi-spheroid configuration. The assembly further includes at least one hook cover coupled to the base via a separate tether, the hook cover adapted for covering the hook of the trailer hitch assembly.

In this embodiment, the assembly includes a number of ball mount covers equal to the number of a corresponding ball mounts.

Also in this embodiment, the assembly comprises a trailer hitch cover assembly is constructed of a flexible, water-proof, open-cell polymer material imparting impact absorption characteristics.

Also in this embodiment, the assembly further comprises a linearly disposed opening that may further assist in the placement or attachment and/or removal of the assembly from the hitch shaft.

In addition, this embodiment includes the ball mount covers coupled to the base via a single tether, the tether comprising a flexible line depending from the base.

Alternatively, the assembly includes each ball mount cover being coupled to the base via separate tethers, wherein the separate tethers each comprise a flexible line depending from the base.

Alternatively, the ball mount cover is coupled each one of the tethers comprises a flexible line depending from the base, each tether securable when not deployed by hook and loop material to the surface of the base

In addition, in this embodiment, each one of the tethers includes hook or loop material coupled to complementary hook or loop material along the elongated surface(s) of the base.

### V. BRIEF DESCRIPTION OF THE DRAWING(S)

The advantages and features of the present invention will become better understood with reference to the following more detailed description and claims taken in conjunction with the accompanying drawings, in which like elements are identified with like symbols, and in which:

FIG. 1 is a side view of the trailer hitch cover assembly, in accordance to one embodiment of the present invention;

FIG. 2 is a side view of the trailer hitch cover assembly, in accordance to another embodiment of the present invention;

FIGS. 3-3A depict various conventional trailer hitch assemblies to which the trailer hitch assembly cover may be applied and incorporated for use therewith; and

FIG. 4 illustrates a trailer hitch cover assembly in accordance to another embodiment of the present invention.

### VI. DESCRIPTION OF THE EMBODIMENT(S)

It will be readily understood that the components of the present invention, as generally described and illustrated in the figures herein, may be arranged and designed in a wide variety of different configurations. Thus, the following detailed description of the embodiments, as represented in the attached figures, is not intended to limit the scope of the invention as claimed, but is merely representative of selected embodiments of the invention.

The features, structures, or characteristics of the invention described throughout this specification may be combined in any suitable manner in one or more embodiments. For example, the usage of the phrases “example embodiments”, “some embodiments”, or other similar language, throughout this specification refers to the fact that a particular feature, structure, or characteristic described in connection with the embodiment may be included in at least one embodiment of the present invention. Thus, appearances of the phrases “example embodiments”, “in some embodiments”, “in other embodiments”, or other similar language, throughout this specification do not necessarily all refer to the same group of embodiments, and the described features, structures, or characteristics may be combined in any suitable manner in one or more embodiments.

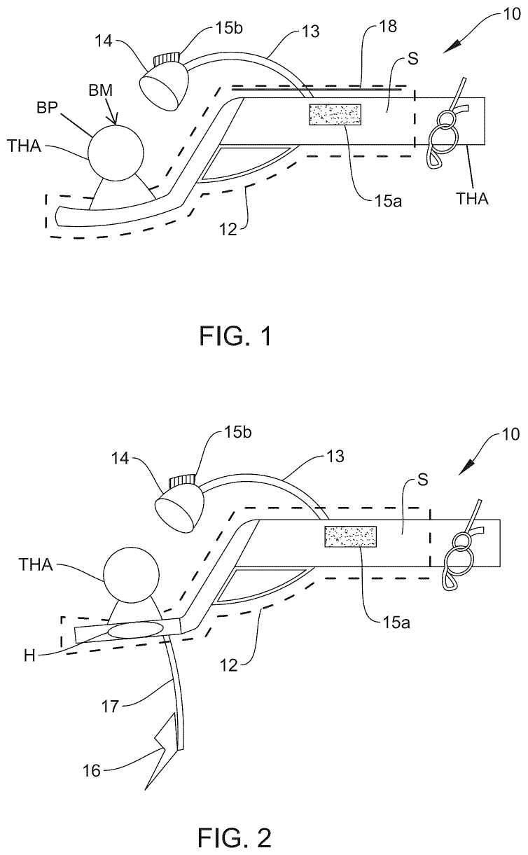

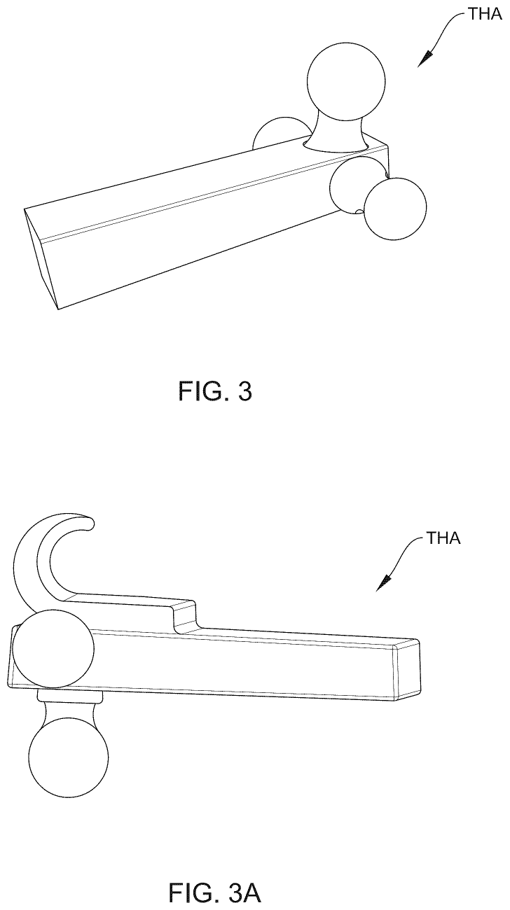

According to at least one embodiment, and consistent with FIG. 1, a trailer hitch cover assembly 10 is disclosed and described, the assembly 10 comprising a unitary mold design construction, wherein the assembly 10 comprises an elongated tubular base 12 for substantially surrounding or encompassing a hitch shaft(S) of a trailer hitch assembly (THA). The base 12 fits about the hitch shaft(S) in a form-fitting manner. The assembly 10 also includes at least one ball mount cover 14 integrally joined to the tubular base 12 via a respective flexible tether 13. The ball mount cover 14 is releasably coupled to the ball portion BP of a ball mount BM. The ball mount cover 14 is sizably adapted and configured for substantially surrounding or encompassing the ball portion BP of a ball mount BM.

The base 12 may be constructed of a flexible, water-proof, open-cell polymer material imparting impact absorption characteristics. The base 12 comprises a flexible material for more easily achieving the attachment and removal of the base 12 to the hitch shaft(S), providing a more durable assembly that will not quickly degrade and deform beyond its starting shape. The base 12 further comprises a water-proof material for enduring exposure to the exterior environmental elements that a trailer hitch assembly (THA) may be expected to encounter, including being stored outside and/or engaging fresh with and saltwater environments. The base 12 comprises a polymeric material that is capable of absorbing impact contact, and in particular, absorbing collisions with human limbs (e.g., legs or parts of legs such as knees) so that injury is either avoided or minimized. The base 12 may be constructed of an open-cell foam material or materials which include, but are not limited to, reticulated foam, neoprene, polyurethane foam, latex, and open cell rubber.

The base 12 comprises a linearly elongated form, wherein the base 12 comprises an enclosure for accepting and retaining the hitch shaft(S) of a trailer hitch assembly (THA). The base 12 is sufficiently elongated to cover the entire length of the hitch(S) shaft(S). In particular, because most hitch shaft configurations are square or rectangular in cross-section, it is envisioned that the base 12 comprises a linearly elongated enclosure of a four-sided configuration for accommodating the common cross-sectional arrangements of most hitch shafts(S). It is also envisioned that this configuration may include a linearly disposed slit or opening 18 that may further assist in the placement or attachment and/or removal of the assembly 10 from the hitch shaft(S).

It is envisioned that the number of ball mount covers 14 is equal in number to a corresponding number of ball mounts disposed on the trailer hitch assembly (THA). Typically, ball mounts range from one to three on a trailer hitch assembly (THA). Accordingly, a number of embodiments are envisioned, including an assembly 10 with base 12 and one ball mount cover 14, an assembly 10 with base 12 and two ball mount covers 14, and an assembly 10 with base 12 and three ball mount covers 14. Usually, multiple ball mount BM arrangements include ball mounts BM of different diameters to accommodate connections of various diameters. Accordingly, it is envisioned that multiple ball mount covers 14 vary in relative size.

The cover(s) 14 is/are constructed from the same materials identified above with the base 12. Thus, the cover(s) 14 impart the same qualities and characteristics as the base 12, wherein there is a flexible, durable material that absorbs collusions and shocks through contact via limbs. Accordingly, the cover(s) 14 is/are expected to yield similar protective qualities at the ball mount BM locations as along the hitch shaft(S) of the trailer hitch assembly (THA).

Each ball mount cover 14 may comprise a variety of configurations. For example, it is envisioned that one arrangement comprises a prolate semi-spheroid configuration (half-prolate spheroid). Similarly, it is envisioned that another arrangement comprises a significantly prolate spheroid configuration (that may cover a substantial surface area of the ball mount).

In one embodiment, each ball mount cover 14 is coupled to the base 12 via a single tether 13. In another embodiment, each ball mount cover 14 is coupled to the base 12 via separate tethers 13. Regardless of the selected embodiment, each one of the tethers 13 comprises a flexible line depending from the base 12. Each one of the tethers 13 includes hook or loop material 15a that may be coupled to complementary hook or loop material 15b along the elongated surface(s) of the base 12, the hook and loop materials 15a and 15b utilized for temporarily securing the cover(s) 14 when not in use cover a ball mount.

In reference to FIG. 2, and in accordance with another embodiment, the assembly 10 further includes a hook cover 16 coupled to the base 12 via a separate tether 17. The hook cover 16 is formed in a manner generally consistent with the hook (H) of a trailer hitch assembly (THA) often used for a connection point with chains and/or the frame of a vehicle.

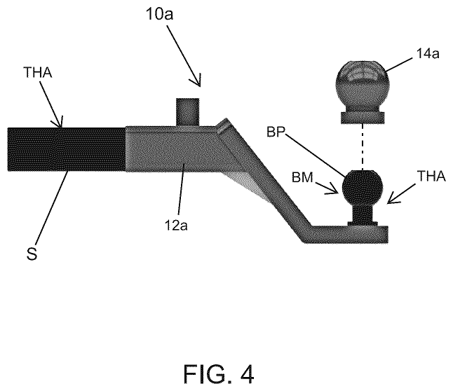

Finally, in reference to FIG. 4, in accordance to another embodiment of the present invention, a trailer hitch cover assembly 10a is disclosed, wherein the assembly 10a comprises an elongated base 12a and a ball mount cover 14a. The elongated tubular base 12a is sizably adapted and configured for substantially surrounding or encompassing a hitch shaft(S) of a trailer hitch assembly (THA) in a form-fitting or contour-fitting manner. The ball mount cover 14a is releasably coupled to the ball portion BP of a ball mount BM. The ball mount cover 14a is sizably adapted and configured for substantially surrounding or encompassing the ball portion BP of a ball mount BM.

It is to be understood that the embodiments and claims are not limited in application to the details of construction and arrangement of the components set forth in the description and/or illustrated in drawings. Rather, the description and/or the drawings provide examples of the embodiments envisioned, but the claims are not limited to any particular embodiment or a preferred embodiment disclosed and/or identified in the specification. Any drawing figures that may be provided are for illustrative purposes only, and merely provide practical examples of the invention disclosed herein. Therefore, any drawing figures provided should not be viewed as restricting the scope of the claims to what is depicted.

The embodiments and claims disclosed herein are further capable of other embodiments and of being practiced and carried out in various ways, including various combinations and sub-combinations of the features described above but that may not have been explicitly disclosed in specific combinations and sub-combinations.

Accordingly, those skilled in the art will appreciate that the conception upon which the embodiments and claims are based may be readily utilized as a basis for the design of other structures, methods, and systems. In addition, it is to be understood that the phraseology and terminology employed herein are for the purposes of description and should not be regarded as limiting the claims.

What is claimed is:

1. A trailer hitch cover assembly comprising:
an elongated tubular base for substantially surrounding a hitch shaft of a trailer hitch assembly in a form-fitting manner; and
at least one ball mount cover integrally joined to the tubular base via a respective flexible tether.

2. The assembly of claim 1, wherein the number of ball mount covers is equal to the number of a corresponding ball mounts.

3. The assembly of claim 1, wherein each ball mount cover comprises a half prolate spheroid configuration.

4. The assembly of claim 1, wherein the trailer hitch cover assembly is constructed of a flexible, water-proof, open-cell polymer material imparting impact absorption characteristics.

5. A trailer hitch cover assembly comprising:
an elongated tubular base for substantially surrounding a hitch shaft of a trailer hitch assembly in a form-fitting manner, wherein the base comprises a linearly elongated form having an enclosure for retaining the hitch shaft of the trailer hitch assembly; and
at least one ball mount cover integrally joined to the tubular base via a respective flexible tether, each one of the ball mount covers having a half prolate spheroid configuration.

6. The assembly of claim 5, wherein the number of ball mount covers is equal to the number of a corresponding ball mounts.

7. The assembly of claim 5, wherein the trailer hitch cover assembly is constructed of a flexible, water-proof, open-cell polymer material imparting impact absorption characteristics.

8. The assembly of claim 5 further comprising a linearly disposed opening assisting in at least one of placement, attachment, and removal of the assembly from the hitch shaft.

9. The assembly of claim 5, wherein the ball mount covers are coupled to the base via a single tether, the tether comprising a flexible line depending from the base.

10. The assembly of claim 5, wherein each ball mount cover is coupled to the base via separate tethers, wherein the separate tethers each comprise a flexible line depending from the base.

11. The assembly of claim 5, wherein the ball mount cover is coupled each one of the tethers comprises a flexible line depending from the base, each tether securable when not deployed by hook and loop material to the surface of the base.

12. The assembly of claim 11, wherein each one of the tethers includes hook or loop material coupled to complementary hook or loop material along the elongated surface(s) of the base.

13. A trailer hitch cover assembly comprising:
an elongated tubular base for substantially surrounding a hitch shaft of a trailer hitch assembly in a form-fitting manner, wherein the base comprises a linearly elongated form having an enclosure for retaining the hitch shaft of the trailer hitch assembly, wherein the trailer hitch assembly has at least one hook connector;
at least one ball mount cover integrally joined to the tubular base via a respective flexible tether, each one of the ball mount covers having a prolate semi-spheroid configuration; and
at least one hook cover coupled to the base via a separate tether, the hook cover adapted for covering the hook of the trailer hitch assembly.

14. The assembly of claim 13, wherein the number of ball mount covers is equal to the number of a corresponding ball mounts.

15. The assembly of claim 13, wherein the trailer hitch cover assembly is constructed of a flexible, water-proof, open-cell polymer material imparting impact absorption characteristics.

16. The assembly of claim 13 further comprising a linearly disposed opening that may further assist in at least one of placement, attachment, and removal of the assembly from the hitch shaft.

17. The assembly of claim 13, wherein the ball mount covers are coupled to the base via a single tether, the tether comprising a flexible line depending from the base.

18. The assembly of claim 13, wherein each ball mount cover is coupled to the base via separate tethers, wherein the separate tethers each comprise a flexible line depending from the base.

19. The assembly of claim 13, wherein the ball mount cover is coupled each one of the tethers comprises a flexible line depending from the base, each tether securable when not deployed by hook and loop material to the surface of the base.

20. The assembly of claim 19, wherein each one of the tethers includes hook or loop material coupled to complementary hook or loop material along the elongated surface(s) of the base.
